(19) United States
(12) Patent Application Publication
(10) Pub. No.: US 2025/0313067 A1
(43) Pub. Date: Oct. 9, 2025

(54) GLASS ASSEMBLY AND WINDOW ASSEMBLY

(71) Applicant: SAINT-GOBAIN GLASS FRANCE, COURBEVOIE (FR)

(72) Inventors: Jiankai YU, SHANGHAI (CN); Siteng MA, SHANGHAI (CN)

(21) Appl. No.: 18/865,549

(22) PCT Filed: May 18, 2023
(86) PCT No.: PCT/CN2023/094929

§ 371 Date: Nov. 13, 2024

(30) Foreign Application Priority Data
May 20, 2022 (CN) 202210556148.8
May 20, 2022 (CN) 202221237531.9

(51) Int. Cl. B60Q 3/64; B32B 17/10; B60J 10/15; B60J 10/70; B60Q 3/208; F21V 8/00

(52) U.S. Cl. CPC B60J 1/001; B32B 17/10036; B32B 17/10146; B32B 17/10541; B32B 17/10761; B32B 17/10788; B60J 10/70; B60Q 3/208; B60Q 3/64; B60Q 3/66; G02B 6/0036; G02B 6/0076; G02B 6/0095; B32B 2551/00; B60J 10/15; B60Q 3/62

(57) ABSTRACT

A glass assembly includes a first glass body having a first surface and a second surface which are oppositely arranged; a second glass body having a third surface facing the second surface and a fourth surface arranged oppositely; a light extraction structure arranged in the second glass body and having a light extraction surface; wherein incident light introduced into the second glass body is extracted at the light extraction structure and is led out from the fourth surface. The glass assembly improves the illumination brightness, create a richer and more comfortable atmosphere and improve the user experience on the premise of not affecting the performance and aesthetics of the glass itself.

### FIELD

The present disclosure relates to the technical field of glass, in particular to a glass assembly and a window assembly using the same.

### BACKGROUND

With the rapid development of automobile industry and the increasing demand of consumers for vehicle functions, luminous glass with lighting effect has been widely valued by vehicle manufacturers and favored by the consumers. The luminous glass usually forms a pattern area on the glass surface based on enamel or ink, or forms a pattern area by laminating a microstructure film layer into the glass. When incident light emitted by a light source arranged on the side or bottom of the glass or integrated in the glass is projected to the pattern area, the light is scattered or diffused through the pattern area due to the change of the surface structure, thus achieving different luminous effects.

### SUMMARY

The present disclosure aims to provide a glass assembly with enhanced luminous function, which optimizes light extraction performance, thereby improving illumination performance and enhancing user experience.

To this end, according to one aspect of the present disclosure, a glass assembly is provided. The glass assembly comprises a first glass body having a first surface and a second surface which are oppositely arranged; a second glass body having a third surface facing the second surface and a fourth surface arranged oppositely; a light extraction structure arranged in the second glass body and having a light extraction surface; wherein incident light introduced into the second glass body is extracted at the light extraction structure and is led out from the fourth surface.

According to the above technical concept, the embodiment of the present disclosure may further include any one or more of the following alternative forms.

In some alternative forms, the light extraction structure is formed in the second glass body by laser engraving.

In some alternative forms, the light extraction surface of the light extraction structure is arranged toward the first glass body or the second glass body.

In some alternative forms, the light extraction structure is formed in the second glass body before or after hot bending process.

In some alternative forms, the first glass body and the second glass body are attached by an intermediate layer having a gray scale.

In some alternative forms, the glass assembly comprises a light source arranged adjacent to the edge of the first glass body and/or the second glass body or arranged at the bottom of the second glass body or embedded in the second glass body.

In some alternative forms, the glass assembly comprises a light guide component configured to conduct the incident light at least toward the light extraction structure in the second glass body.

In some alternative forms, the glass assembly comprises a light source embedded in an opening arranged on the second glass body, and a sealing component arranged between the second surface and the third surface is provided at the opening.

In some alternative forms, the sealing component is configured as a reflector, so that light incident on the sealing component is reflected back into the second glass body.

In some alternative forms, a black ink is arranged at the opening to shield the opening and the light source in the opening.

According to another aspect of the present disclosure, a window assembly is provided. The window assembly comprises the above glass assembly, wherein the window assembly comprises door, window, curtain wall, vehicle window glass, airplane glass or ship glass.

In some alternative forms, the window assembly is a vehicle window glass comprising front windshield, rear windshield, skylight glass, vehicle door glass or corner window glass, wherein the first surface of the first glass body faces the outside of the vehicle and the fourth surface of the second glass body faces the inside of the vehicle.

The glass assembly of the present disclosure can obviously improve the illumination brightness, create a richer and more comfortable atmosphere and improve the user experience on the premise of not affecting the performance and aesthetics of the glass itself. The glass assembly of the present disclosure is easy to implement and has obvious performance improvement, and can be applied to various occasions through the combination of various ways to meet the diversified requirements of users.

### BRIEF DESCRIPTION OF THE DRAWINGS

Other features and advantages of the present disclosure will be better understood by the following alternative embodiments described in detail in conjunction with the accompanying drawings, in which the same reference numerals identify the same or similar parts, in the drawings:

FIG. 1 is a schematic view of a glass assembly according to an embodiment of the present disclosure, wherein incident light contacts a bottom light extraction surface of a light extraction structure facing a fourth surface and is reflected, scattered or diffused;

FIG. 2 is similar to FIG. 1, wherein the incident light contacts a top structure of the light extraction structure facing a third surface and is reflected, scattered or diffused;

FIG. 3 is a schematic view of the arrangement of a light source in a glass assembly according to an embodiment of the present disclosure;

FIG. 4 is a schematic view of the arrangement of a light source in a glass assembly according to another embodiment of the present disclosure;

FIG. 5 is a schematic view of the arrangement of a light source in a glass assembly according to yet another embodiment of the present disclosure;

FIG. 6 is a schematic view of a glass assembly according to an embodiment of the present disclosure, in which the light source shown in FIG. 5 is incorporated.

### DETAILED DESCRIPTION OF EMBODIMENTS

The implementation and use of the embodiments are discussed in detail below. However, it should be understood that the specific embodiments discussed merely exemplify the specific ways of implementing and using the present disclosure, and do not limit the scope of the disclosure. When describing the structural positions of various components, such as the directions of upper, lower, top, bottom, etc., the description is not absolute, but relative. When the various components are arranged as shown in the figures, these directional expressions are appropriate, but when the positions of the various components in the figures would be changed, these directional expressions would also be changed accordingly.

In this context, the expression “comprising” or similar expressions “including”, “containing” and “having” which are synonymous are open, and do not exclude additional unlisted elements, steps or ingredients. The expression “consisting of . . . ” excludes any element, step or ingredient that is not specified. The expression “consisting essentially of . . . ” means that the scope is limited to the specified elements, steps or ingredients, plus the optional elements, steps or ingredients that do not materially affect the basic and new features of the claimed subject matter. It should be understood that the expression “comprising” covers the expressions “consisting essentially of” and “consisting of”.

In this context, the terms “first”, “second” and so on are not used to limit the sequence and the number of components unless otherwise stated.

In this context, the meanings of “a plurality of” and “multiple layers” refer to two or more than two, unless otherwise specified.

In this context, unless otherwise specified, the terms such as “installation”, “connection” and “attach” should be understood broadly. For example, it can be fixed connection, detachable connection or integrated; it can be directly connected or indirectly connected through an intermediate medium, and it can be the internal communication of two elements or the interaction between two elements. For those skilled in the art, the specific meanings of the above terms in this context can be understood according to specific situations.

In this context, “glass” is an amorphous inorganic nonmetallic material, which is generally made of a variety of inorganic minerals (such as quartz sand, borax, boric acid, barite, barium carbonate, limestone, feldspar, soda ash, etc.) as main raw materials, and a small amount of auxiliary raw materials. Its main components are silica and other oxides. In the various described embodiments, unless otherwise specified, the thickness of the glass is the thickness commonly used in the art, and the thickness of each laminated structure on the glass is suitable for the conventional range, and is not limited as shown in the figures. In addition, although it is shown as plane glass in the figures, the glass of the present disclosure may also be curved glass. In various embodiments, it is described as an independent glass body or a glass plate; however, in some cases, the surface of the glass body can also use a single layer or multiple layers of special coating to improve privacy and/or thermal insulation and/or comfort.

Hereinafter, the glass assembly applied to a vehicle window glass will be described, but it is not excluded that the glass assembly can be applied to other environments such as door, window, curtain wall, airplane glass or ship glass. When the glass assembly is described as a vehicle window glass for a vehicle, “outside” and “inside” refer to the directions relative to vehicle body, “outside” refers to the direction away from the vehicle body and “inside” refers to the direction facing the vehicle body. It should be understood that the vehicle window glass according to the embodiment of the present disclosure includes, but is not limited to, front windshield, rear windshield, skylight glass, vehicle door glass or corner window glass, which can provide different illumination effects based on different requirements.

In the ever-changing automobile industry, the glass assembly with lighting and decorative effects has been widely used in such as vehicle skylight of mid-to-high-end vehicles, which can not only achieve the effects of light shading and/or color change, but also form lighting effects with different patterns by combining coatings and/or sandwich structures. In the prior art, the light extraction technology based on enamel or ink coating on the glass surface, or the light extraction film or light guide film laminated in the glass to form a pattern area, or the light emitting diode (LED) technology integrated in the glass are mostly adopted. However, the above-mentioned prior art cannot satisfy the manufacturers and users with respect to the market demand that the requirement of the brightness of the pattern after the light source is turned on and inconspicuous or invisible pattern when the light source is turned off.

The inventor realized that engraved luminous glass has been widely used in the fields of architecture and daily life, such as luminous stair handrail, luminous building exterior wall glass, luminous billboard (made of transparent materials such as glass and polymethylmethacrylate (PMMA)), etc., but it is rarely used in the vehicle glass. In addition, the engraved pattern on the engraved luminous glass is mainly engraved on the surface of the glass to realize luminescence. The inventor found that the microstructure formed in the glass can not only provide relatively high brightness lighting effect, but also help to meet the above market demand, and also have the beneficial effects of environmental protection and energy saving.

Based on the above concept, the present disclosure provides an improvement on the glass assembly. In various described embodiments, the glass assembly comprises a first glass body and a second glass body, and a light extraction structure having a light extraction surface is arranged in the second glass body. Here, the light extraction surface refers to the light-emitting structural surface on the light extraction structure that significantly changes emission angle or direction of light. The surface of the light-emitting extraction structural surface can be formed as plane or non-plane, such as semi-sphere, cone, triangle, trapezoid and the like. When the light contacts the local or whole light extraction surface of the light extraction structure, the light is reflected, scattered or diffused to present an illumination effect. The light extraction structure can be arranged continuously or discontinuously, or generates different display patterns or display effects through different distributions. Similarly, the light extraction surface can be continuously or discontinuously arranged on the light extraction structure. In addition, depending on the microscopic texture or pattern formed by the light extraction structure, the present disclosure also provides an illumination effect. In other words, when the light source is turned on, the glass assembly presents the required pattern or display effect, and when the light source is turned off, the glass assembly has different transparent effects, that is, transparent or translucent, according to the texture line diameter of the light extraction structure. This is especially beneficial to the lighting requirement of the vehicle window glass, such as vehicle skylight.

According to the present disclosure, the light extraction structure is formed in the second glass body by laser engraving. The so-called laser engraving is 3D laser internal engraving glass technology. The laser generates pulses in a very short time, and the energy can instantly cause the glass body to be cracked by heat, thus producing tiny white spots and engraving a predetermined shape inside the glass body, while the rest of the glass body remains intact. Using the laser engraving, the laser beam engraves inside the glass, which has no dust, volatile substances, emissions and consumables, and does not cause any pollution to the external environment. Compared with the traditional techniques of sand blasting engraving, screen printing and etching on the glass surface to form light extraction structure, the working environment of workers can be greatly improved. In addition, the laser has the advantages of low energy consumption and energy saving.

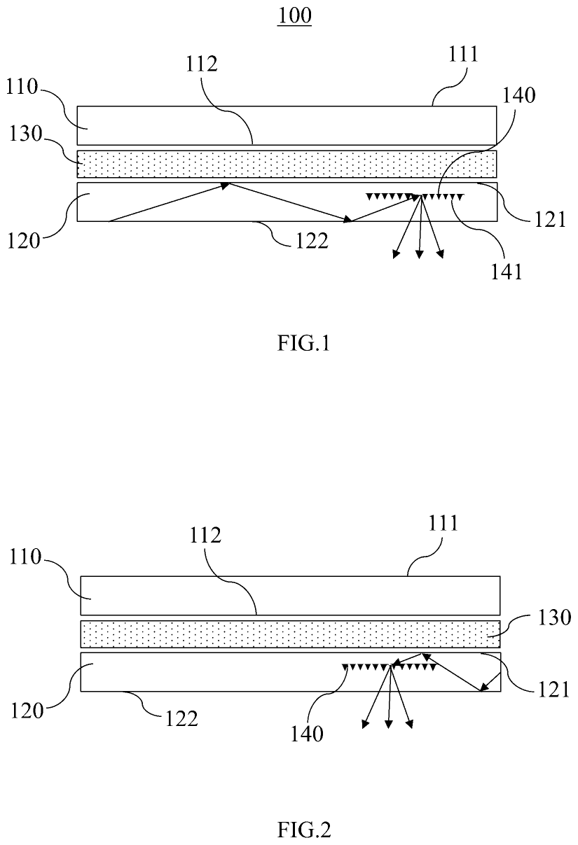

FIGS. 1 and 2 illustrate a glass assembly 100 according to an embodiment of the present disclosure, which includes a first glass body 110 having a first surface 111 and a second surface 112, and a second glass body 120 having a third surface 121 and a fourth surface 122. For the vehicle window glass, the first glass body 110 may be called external glass, and the second glass body 120 may be called internal glass. An intermediate layer 130 is sandwiched between the first glass body 110 and the second glass body 120 to bond them together. The intermediate layer 130 is polyvinyl butyral (PVB) or ethylene-vinyl acetate copolymer (EVA), for example. In the second glass body 120, a light extraction structure 140 having a light extraction surface 141 is formed according to a desired pattern by laser engraving. It should be understood that the light extraction structure is microstructure or micro-texture, and the size is in the micron or even nanometer level. Depending on different design requirements, the light extraction surface 141 of the light extraction structure 140 can be arranged toward the first glass body 110 or the second glass body 120, with the purpose that incident light introduced into the second glass body 120 is extracted at the light extraction structure and tends to be led out from the fourth surface 122. In FIGS. 1 and 2, the light extraction surface 141 is exemplarily shown in the form of a triangular sharp corner, and is arranged toward the fourth surface 122 of the second glass body 120, so as to obtain the illumination effect inside the vehicle and improve the pattern display effect. As shown by the arrows in FIG. 1, the incident light introduced into the second glass body 120 is totally reflected in the second glass body 120. When the incident light contacts the microstructure or the light extraction surface 141 locally generated on the bottom surface of the light extraction structure 140 facing the fourth surface that needs to illuminate the pattern, the light is reflected, scattered or diffused, and part of the light is led out from the fourth surface 122 to achieve the illumination effect. In the mode shown in FIG. 2, the light contacts the microstructure locally generated on the top surface of the light extraction structure 140 facing the third surface, which can also make the light reflected, scattered or diffused, and part of the light is led out from the fourth surface 122 to achieve the illumination effect.

Through the above designs, the light extraction structure is provided in the second glass body of the glass assembly, and after the incident light entering the second glass body reaches the light extraction structure, the incident light is reflected, scattered or diffused by the light extraction structure and led out from the fourth surface of the second glass body. The light extraction structure is formed by laser engraving, so that the glass assembly of the present disclosure enhances the illumination effect on the internal glass in an environmentally-friendly and energy-saving manner with low cost. It can not only realize high automation, but also realize standardized, digital and networked production, or realize remote monitoring and operation, which effectively reduces the labor intensity of workers, improves the working environment and greatly improves the production efficiency and product grade. Depending on different application requirements, the light extraction structure formed by laser engraving can produce different display patterns or display effects through different distributions, such as stars and the moon.

It should be understood that the reflection, scattering or diffusion of the light after it contacts the light extraction structure does not exclude the transmission of the light toward the first glass body. In some embodiments, the intermediate layer 130 with a gray scale, such as PVB with a gray scale, can be used to play a role in shading. For example, when the glass assembly is applied to the vehicle window glass, the incident light for illumination can be prevented from emitting toward the first glass body after contacting the light extraction structure to affect the lighting effect, or the strong light from the outside of the first glass body can be prevented from entering the vehicle to affect the comfort. In addition, the intermediate layer with a gray scale also makes the privacy function possible.

When the glass assembly of the present disclosure is applied to the vehicle window glass, the formation of the light extraction structure in the second glass body can be realized in two ways. The first way is to carry out the laser engraving before hot bending process, that is, engraving the microstructure inside the planar (2D) glass then putting the glass having the light extraction structure into a mold to be hot bent into curved (3D) glass, and finally carrying out the lamination process of the glass assembly. The second way is to carry out the laser engraving after the hot bending process, that is, directly engraving inside the 3D glass and then laminating the glass assembly. The above two ways can be adjusted as required depending on different applications and material selection of the glass, as long as the laser engraving of the light extraction structure can be realized without destroying the strength and performance of the glass, or the strength or performance of the engraved glass meets the national compulsory test standards.

Especially for the first way, since the process of the laser engraving is to destroy the physical structure inside the glass, the inside of the glass is broken to produce white spots to form microstructure or pattern, and the hot bending process after engraving has certain requirements for the pattern. In other words, in order to prevent the glass from breaking in the hot bending process, it is advantageous to design the pattern as a non-continuous line or a non-continuous and large-area pattern, so that laser damage points inside the glass will not be concentrated in a certain area, thus avoiding affecting the overall strength of the glass. From another point of view, the pattern is designed to be thinner in line diameter and thinner in glass damage thickness, which also makes the pattern difficult to be observed by users after the light source is turned off, thus presenting a substantially transparent effect.

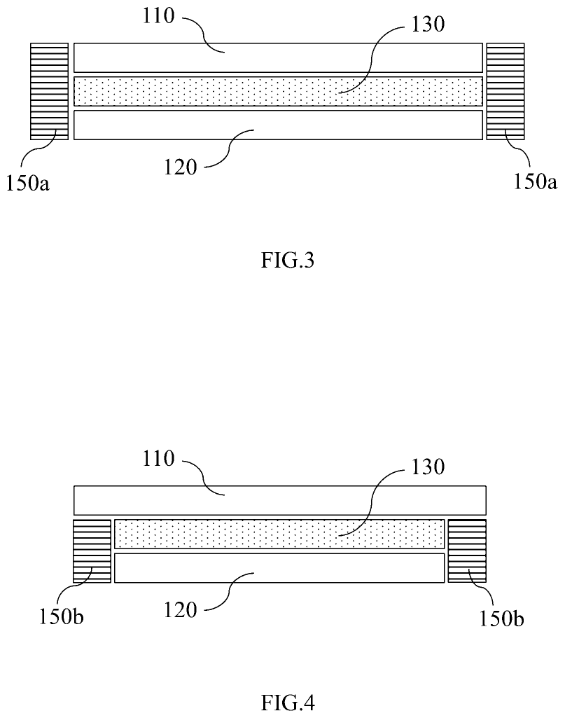

FIGS. 3 to 5 respectively illustrate different arrangements of the light source in the glass assembly. Alternatively, the light source is, for example, a point or linear light source integrated inside the glass body, or a light source attached to the edge of the glass body in an adjacent, attached manner, such as an LED light-emitting strip, or a point LED with a light guide. Depending on the shape of the glass body, the light source can be arranged on one or more edges of the glass body. For example, when the glass body is substantially triangular, the light source can be arranged on one edge of the glass body, and when the glass body is substantially quadrilateral, the light source can be arranged on two opposite edges of the glass body. Here, the light source integrated in the glass body should be understood as integrated in the second glass body, and incident point of the light source and the light extraction structure are approximately at the same horizontal level. In an embodiment where the side edge of the glass assembly emits the incident light, the light source can be formed as a package (e.g., encapsulated in an encapsulation) or assembled at the edge of the glass body in other fixed forms. In an embodiment shown in FIG. 3, a light source 150a may be arranged at the edges of the first glass body 110 and the second glass body 120. In an embodiment shown in FIG. 4, the size of the first glass body 110 is larger than that of the second glass body 120. In this case, a light source 150b may be arranged only at the edge of the second glass body 120. In an embodiment shown in FIG. 5, a light source 150c is integrated in the second glass body 120 by being embedded in an opening 123 provided in the second glass body 120. The cross section of the opening 123 may be circular, rectangular or other suitable shapes. It should be understood that in the above embodiments, the light sources 150a, 150b and 150c can all be one or more light sources, for example, a strip-shaped light band arranged in a ring shape or a plurality of point-shaped light sources distributed at intervals, and the illustration is not limiting. In the above embodiments, the light source may be a direct light source, or may further include a light guide component configured to conduct the incident light emitted by the light source at least toward the light extraction structure in the second glass body, so as to be suitable for total reflecting of the light at non-light extraction structure and reflecting, scattering or diffusing at the light extraction structure. It should be understood that the light guide component can be any suitable optical device or microstructure optical device, such as light guide bar, to realize the above adjustment of light direction.

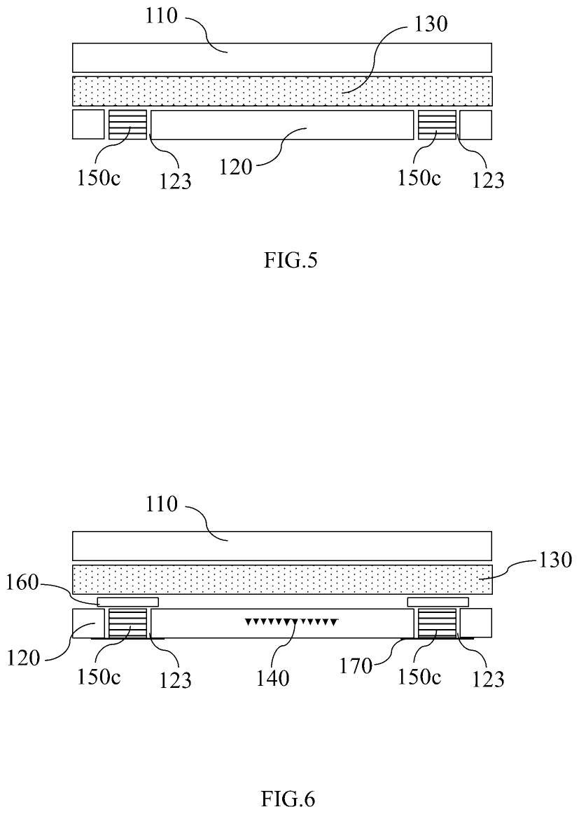

FIG. 6 illustrates a glass assembly incorporating the light source in FIG. 5 according to an embodiment of the present disclosure. The light extraction structure 140 is arranged in the second glass body 120, and the light source 150c is integrated in the second glass body 120 by being embedded in the opening 123 arranged on the second glass body 120. Optionally, a sealing component 160 is provided between the opening 123 of the second glass body 120 and the intermediate layer 130, and a black ink 170, for example, may be provided at the corresponding opening 123 to shield the opening 123, so that the opening 123 and the light source 150c in the opening 123 cannot be observed from the outside of the glass assembly. The sealing component 160 is, for example, an aluminum foil. Due to the mirror effect on the surface of the aluminum foil, in some cases, the sealing component 160 can be used as a reflector to reflect the light incident on it back into the second glass body 120 to reduce the illumination loss while playing a sealing effect.

In one embodiment, the first glass body 110 is made of VG10 glass with a thickness of 2.1 mm, the intermediate layer 130 is made of gray PVB with a thickness of 0.76 mm, and the second glass body 120 is made of ordinary white glass or ultra-white glass which has no influence on the color of light and can have a thickness range of 0.7˜4.0 mm. The light extraction structure 140 is formed in the second glass body 120 by laser engraving. The light source 150c is embedded in the opening 123 of the second glass body 120 and isolated from the intermediate layer 130 by the sealing component 160 such as aluminum foil. Experiments were carried out on the glass assembly of the present disclosure and a comparative glass assembly with the same size and material. The pattern design all adopted pentagram, the pattern size was 40 mm×40 mm, and the pattern outline was composed of a plurality of lines with a line diameter of 0.5 mm. Under the same test environment, the engraved pattern provided in the glass assembly of the present disclosure obviously improves the illumination brightness, and the average brightness at the test pattern is 30.66cd/m2. Compared with the pattern formed by coating enamel on the fourth surface of the second glass body, the brightness is improved by about 5.25 times, in which the enamel is luminescent ink, and the main materials are usually silicon dioxide, alumina, titanium dioxide, etc. Compared with the pattern formed by laser engraving on the fourth surface of the second glass body, the brightness is improved by about 3.38 times. Compared with the pattern formed by laser engraving on the third surface of the second glass body, the brightness is improved by about 26.34 times. The measuring instrument adopts a commercially available image brightness meter, such as LumiCam 1300. In addition, whether in a well-lit test environment or a dimly lit test environment, the pattern in the glass assembly of the present disclosure can be clearly visible when the light source is turned on, and the glass becomes transparent or translucent when the light source is turned off.

As can be seen from the above description, the light extraction structure of the glass assembly of the present disclosure is formed in the second glass body by laser engraving, which increases the reflection, scattering or diffusion of the incident light at the light extraction structure, significantly enhances the light extraction effect, effectively improves the illumination brightness while ensuring the illumination effect, and has the beneficial effects of simple process, obvious performance improvement and the like.

It should be understood here that the embodiments shown in the drawings only illustrate the optional architectures, shapes, sizes and arrangements of various optional components of the glass assembly according to the present disclosure; however, it is only illustrative rather than restrictive, and other shapes, sizes and arrangements can be adopted without departing from the spirit and scope of the present disclosure.

The technical content and technical features of the present disclosure have been disclosed above. However, it can be understood that those skilled in the art can make various changes and improvements to the above disclosed concept under the creative idea of the present disclosure, all of which fall within the protection scope of the present disclosure. The description of the above embodiments is illustrative rather than restrictive, and the protection scope of the present disclosure is determined by the claims.

1. A glass assembly comprising:
a first glass body having a first surface and a second surface which are oppositely arranged;
a second glass body having a third surface facing the second surface and a fourth surface arranged oppositely;
a light extraction structure arranged in the second glass body and having a light extraction surface;
wherein incident light introduced into the second glass body is extracted at the light extraction structure and is led out from the fourth surface.

2. The glass assembly according to claim 1, wherein the light extraction structure is formed in the second glass body by laser engraving.

3. The glass assembly according to claim 2, wherein the light extraction surface of the light extraction structure is arranged toward the first glass body or the second glass body.

4. The glass assembly according to claim 2, wherein the light extraction structure is formed in the second glass body before or after hot bending process.

5. The glass assembly according to claim 2, wherein the first glass body and the second glass body are attached by an intermediate layer having a gray scale.

6. The glass assembly according to claim 1, wherein the glass assembly comprises a light source arranged adjacent to the edge of the first glass body and/or the second glass body or arranged at the bottom of the second glass body or embedded in the second glass body.

7. The glass assembly according to claim 6, wherein the glass assembly comprises a light guide component configured to conduct the incident light at least toward the light extraction structure in the second glass body.

8. The glass assembly according to claim 6, wherein the glass assembly comprises a light source embedded in an opening arranged on the second glass body, and a sealing component arranged between the second surface and the third surface is provided at the opening.

9. The glass assembly according to claim 8, wherein the sealing component is configured as a reflector, so that light incident on the sealing component is reflected back into the second glass body.

10. The glass assembly according to claim 8, wherein a black ink is arranged at the opening to shield the opening and the light source in the opening.

11. A window assembly comprising a glass assembly according to claim 1, wherein the window assembly comprises door, window, curtain wall, vehicle window glass, airplane glass or ship glass.

12. The window assembly according to claim 11, wherein the window assembly is a vehicle window glass comprising front windshield, rear windshield, skylight glass, vehicle door glass or corner window glass, and wherein the first surface of the first glass body faces the outside of the vehicle and the fourth surface of the second glass body faces the inside of the vehicle.
